(19) United States
(12) Patent Application Publication
(10) Pub. No.: US 2002/0142694 A1
(43) Pub. Date: Oct. 3, 2002

(54) Method for dissipating heat on address electrode drive chips of plasma display panel

(76) Inventors: Yao-Hung Lai, Taipei (TW); Kuang-Lang Chen, Taipei (TW)

Correspondence Address: BACON & THOMAS, PLLC, 625 SLATERS LANE, FOURTH FLOOR, ALEXANDRIA, VA, 22314

(21) Appl. No.: 09/870,492

(22) Filed: Jun. 1, 2001

(30) Foreign Application Priority Data
Apr. 3, 2001 (TW) 090108031

(51) Int. Cl. G09G 3/10

(52) U.S. Cl. 445/1

(57) ABSTRACT

A method for dissipating heat on address electrode drive chips of plasma display panel (PDP) comprises the steps of connecting an external voltage pulse circuit to the address electrode drive chips for driving; enabling a control circuit to control a switching sequence of switches in both the external voltage pulse circuit and each address electrode drive chip; generating an external voltage level or zero volt in each address electrode drive chip and applying the same to each address electrode of the PDP; and totally transferring a switching loss in the switches of each address electrode drive chip during switching to the switches of the external voltage pulse circuit. The method can prevent heat caused by switches switching loss from accumulating on drive chips.

### FIELD OF THE INVENTION

The present invention relates to plasma display panels (PDPs) and more particularly to an effective method for dissipating heat on address electrode drive chips of PDP.

### BACKGROUND OF THE INVENTION

A manufacturing process of a conventional alternating current discharge type plasma display panel (PDP) 10 is shown in FIG. 1. First, two different activation layers are formed on glass substrates 11 and 12 respectively. Then seal the peripheries of the glass substrates together. A mixed gas consisting of helium (He), neon (Ne), and xenon (Xe) (or argon (Ar)) having a predetermined mixing volume ratio is stored in a discharge space formed in between the glass substrates. A front plate 11 is defined as one that facing viewers. A plurality of parallel spaced transparent electrodes 111, a plurality of parallel spaced bus electrodes 112, a dielectric layer 113, and a protective layer 114 are formed from the front plate 11 inwardly. From a corresponding rear plate 12 inwardly, a plurality of parallel spaced data electrodes 121, a dielectric layer 124, a plurality of parallel spaced ribs 122, and a uniform phosphor layer 123 are formed. When a voltage is applied on electrodes 111, 112, and 121, dielectric layers 113 and 124 will discharge in discharge cell 13 formed by adjacent spaced ribs 122. As a result, a ray having a desired color is emitted from phosphor layer 123.

Conventionally, in PDP 10 a plurality of parallel spaced transparent electrodes 111 are formed on inner surface of front plate 11 by sputtering and photolithography (or printing). Then a plurality of parallel spaced bus electrodes 112 are formed on the transparent electrodes 111 respectively by plating (or sputtering) and photolithography. The line impedance of the transparent electrodes 111 may be reduced by the provision of bus electrodes 112. In the following description, two adjacent transparent electrodes 111 (including bus electrodes 112) on the front plate 11 are represented by X electrode and Y electrode respectively. A triple electrode is formed by X electrode, Y electrode and corresponding data electrode 121 on the rear plate 12. When a voltage is applied on the triple electrode, dielectric layers 113 and 124 will discharge in discharge cell 13 formed by adjacent spaced ribs 122. Hence, UV rays are emitted from the mixed gas stored therein. And in turn, phosphor layer 123 in discharge cell 13 is activated by the UV rays. As an end, a visible light is generated by red, green and blue phosphor layers, resulting in an image showing.

Referring to FIG. 2, a cross-section and structure of a conventional alternating current type plasma display panel (PDP) 10 is shown. As shown, PDP 1 comprises an X electrode 2₁, Y electrodes 3₁-3₁₀₀₀, address A electrodes 4₁-4_{M}, a display grid 5, a barrier rib 6, and Y electrode display lines 7₁-7₁₀₀₀. X electrode 2₁ and Y electrode 3₁-3₁₀₀₀ are on the same horizontal level. Address electrodes 4₁-4_{M} are perpendicular to X and Y electrodes respectively. Each of X and Y electrodes has its specific function. For example, X electrode 2₁ acts to write and maintain discharge. Y electrodes 3₁-3₁₀₀₀ act to scan and maintain discharge. Address electrodes 4₁-4_{M} act to address. By effecting a cooperation among above electrodes, it is possible to show an image on panel 1.

FIG. 3 is a schematic diagram of drive circuit of PDP 10. The drive circuit comprises address electrode drive chips 5₁-5₅, Y electrode drive chips 6₁-6₄, a Y electrode drive circuit 7, an X electrode drive circuit 8 and a control circuit 9. Address electrode drive chips 5₁-5₅ receive control signal from control circuit 9 for driving address electrodes 4₁-4_{M} in order to effect an addressing. Y electrode drive chips 6₁-6₄ receive control signal from control circuit 9 for driving individual display line of Y electrodes 3₁-3₁₀₀₀ in order to scan and maintain discharge. Y electrode drive circuit 7 is controlled by control circuit 9 for controlling timing. Y electrode drive circuit 7 cooperates with Y electrode drive chips 6₁-6₄ for distinguishing scan/address cycle from discharge maintaining cycle. X electrode drive circuit 8 receives control signal from control circuit 9 for driving X electrode in order to effect a writing and a discharge maintaining of PDP. By effecting a control on address electrode drive chips 5₁-5₅, Y electrode drive chips 6₁-6₄, Y electrode drive circuit 7, and X electrode drive circuit 8 and a cooperation among them, it is possible to drive the circuitry of panel 1 and show an image thereon.

FIG. 4 is a circuit diagram of drive circuit of PDP. As shown, X electrode drive circuit 8 comprises a discharge maintaining circuit 81, a writing circuit 82, and an energy recovery circuit 83. Circuit 82 acts to excite each display grid for emitting light and exciting particles. Discharge maintaining circuit 81 acts to cause each display grid having excited particles to emit light and accumulate particles to be excited in a next cycle. Energy recovery circuit 83 acts to reduce energy lost in circuit parasite elements for transferring energy stored in display grids to an external storage element. Thus the stored energy may be sent to display grids before a next cycle starts. With this, it is possible to recover more than 90% of energy consumed in circuit parasite element for future use. Y electrode drive circuit 7 comprises a scan circuit 71, a discharge maintaining circuit 72, and an energy recovery circuit 73. Scan circuit 71 acts to write data to be displayed into panel sequentially during scanning cycle. Further, scan circuit 71 acts to divide Y electrode into selected display lines and unselected display lines so that address electrode may address correctly. Y electrode drive chip 6 cooperates with scan circuit 71 and discharge maintaining circuit 72 for sequentially activating respective circuits. Address electrode drive chip 5 acts to write data to be displayed into selected display lines on Y electrode through address electrode in order to update display data on address circuit.

Address electrode drive chip 5 acts to provide an external voltage (Va) (or zero volt) to address electrode. Thus address electrode drive chip 5 must switch an internal switch (e.g., semiconductor circuit) in order to output such external voltage (Va) (or zero volt). In a typical address drive chip, there are at least 64 switches. When address electrode drive chip generates an external voltage (Va) (or zero volt) and output the same to PDP, such drive chip must sustain energy loss due to multiple switchings. Such loss mainly is switching loss in capacitive load caused by switching the switches. FIG. 5 is an equivalent circuit diagram of the address electrode drive chip. As shown, a first semiconductor circuit of switch is designated by S₁. A second semiconductor circuit of switch is designated by S₂. R₁ and R₂ are equivalent resistors of switches S₁ and S₂ respectively. Va is an external voltage source. C is capacitive load. In FIG. 6, switch S₁ is closed and switch S₂ is open. Hence, power consumed in resistor R₁ is P_{R1}=CVa²/2 and energy stored in capacitive load C is P_{C}=CVa²/2. Further, in FIG. 7, switch S₁ is open and switch S₂ is closed. Hence, energy stored in capacitive load C (i.e., P_{C}=CVa²/2) is fed to resistor R₂. Thus the consumed energy in resistor R₂ is P_{R2}=CVa²/2 and switching loss in capacitive load C per discharge is P_{T}=P_{R1}+P_{R1}=CVa². For example, the switching loss is CVa²f if the discharge times per second is f. Moreover, a so-called “thousand-bird pattern” is formed on cells of PDP as shown in FIG. 8. At the instinct of switching in address electrode drive chip, address electrodes on PDP is about equivalent to the capacitive load on the drive chip. Hence, energy loss permissible in drive chip is CVa²f. Such loss in converted into heat in the drive chip. In the case that the discharge times per second f is extremely high, the energy loss in address electrode drive chip is increased accordingly. This may burn out the drive chip eventually. In response, an automatic power control (W-APC) is developed by PDP designers and manufacturers for solving above serious power consumption on address electrode drive chip while displaying “thousand-bird pattern”. The technique proposed by W-APC is to control the switch times of address electrode drive chip for reducing switching loss in drive chip and reducing power consumption of PDP accordingly. However, it may also degrade image quality shown on PDP (e.g., HDTV). Therefore, it is not practical.

### SUMMARY OF THE INVENTION

It is thus an object of the present invention to provide a method for dissipating heat on a plurality of address electrode drive chips of a plasma display panel (PDP). The method comprises the steps of: (a) connecting an external voltage pulse circuit to the address electrode drive chips for driving; (b) enabling a control circuit to control a switching sequence of a plurality of switches in both the external voltage pulse circuit and each of the address electrode drive chips; (c) generating an external voltage level or zero volt in each of the address electrode drive chips and applying the same to each of a plurality of address electrodes of the PDP; and (d) totally transferring a switching loss in the switches of each the address electrode drive chips during switching to the switches of the external voltage pulse circuit.

In one aspect of the present invention, when an output voltage of each of the address electrode drive chips is the external voltage, in one timing cycle of the external voltage pulse circuit and each of the address electrode drive chips, comprising the steps of: (e) enabling the control circuit to switch the third switch of each of the address electrode drive chips to a closed state and the fourth switch thereof to an open state for preventing heat from generating because there is no switching loss in the third switch; (f) enabling the control circuit to switch the first switch to the closed state and forming a first current path by the external voltage, the first current path passing from the external voltage, the first switch, the third switch, the external capacitor, and the ground terminal to return to the external voltage, thereby totally transferring energy loss due to the switchings to the first switch; (g) enabling the control circuit to switch the first switch to the open state and the second switch to the closed state and forming a second current path by the external voltage, and the second current path passing from the ground terminal, the external capacitor, the third switch, and the second switch to return to the ground terminal wherein charges accumulated in the external capacitor due to charging by the external voltage is discharged to the ground terminal for reducing a voltage of the external capacitor to zero and totally transfers energy loss due to the switchings to the second switch; and (h) enabling the control circuit to switch the first, second, and third switches to the open state and the fourth switch to the closed state and forming a third current path by the external voltage, and the third current path passing from the ground terminal, the external capacitor, and the fourth switch to return to the ground terminal wherein there is no current on the third current path since the voltage on the external capacitor is zero in the step (g) and prevents heat from generating because there is no switching in both the third and fourth switches.

In another aspect of the present invention, when the output voltage of each of the address electrode drive chips is zero, in the other timing cycle of the external voltage pulse circuit and each of the address electrode drive chips, comprising the steps of: (i) enabling the control circuit to switch the first and fourth switches to the closed state and the second and third switches to the open state and forming the third current path by the external voltage, and the third current path passing from the ground terminal, the external capacitor, and the fourth switch to return to the ground terminal wherein there is no output voltage since the voltage on the external capacitor is zero; (j) enabling the control circuit to switch the first switch to the open state and the second switch to the closed state and forming the third current path by the external voltage, and the third current path passing from the ground terminal, the external capacitor, the fourth switch, and the second switch to return to the ground terminal wherein there is no output voltage since the voltage on the external capacitor is zero; and (k) enabling the control circuit to switch the second switch to the open state and forming the third current path by the external voltage, and the third current path passing from the ground terminal, the external capacitor, the fourth switch, and the second switch to return to the ground terminal wherein there is no output voltage since the voltage on the external capacitor is zero.

The above and other objects, features and advantages of the present invention will become apparent from the following detailed description taken with the accompanying drawings.

### BRIEF DESCRIPTION OF THE DRAWINGS

FIG. 1 is a sectional view of a conventional alternating current type PDP;

FIG. 2 is schematic diagram showing a structure of PDP in FIG. 1;

FIG. 3 is schematic diagram of drive circuit of PDP in FIG. 1;

FIG. 4 is a circuit diagram of drive circuit of PDP in FIG. 1;

FIG. 5 schematically showing an equivalent circuit diagram of the address electrode drive chip;

FIG. 6 is a circuit diagram showing switch S1 closed and switch S2 open of FIG. 5;

FIG. 7 is a circuit diagram showing switch S1 open and switch S2 closed of FIG. 5;

FIG. 8 is a top plan view of “thousand-bird pattern” formed on cells of PDP;

FIG. 9 is a circuit diagram of an external voltage pulse circuit incorporated in a plurality of address electrode drive chips on plasma display panel according to the invention;

FIG. 10 schematically shows an equivalent circuit diagram of address electrode drive chip of FIG. 9;

FIG. 11 is a timing diagram of waveforms illustrating relationship of switches versus output voltage; and

FIGS. 12 to 18 are circuit diagrams illustrating various on/off combinations of switches in operation.

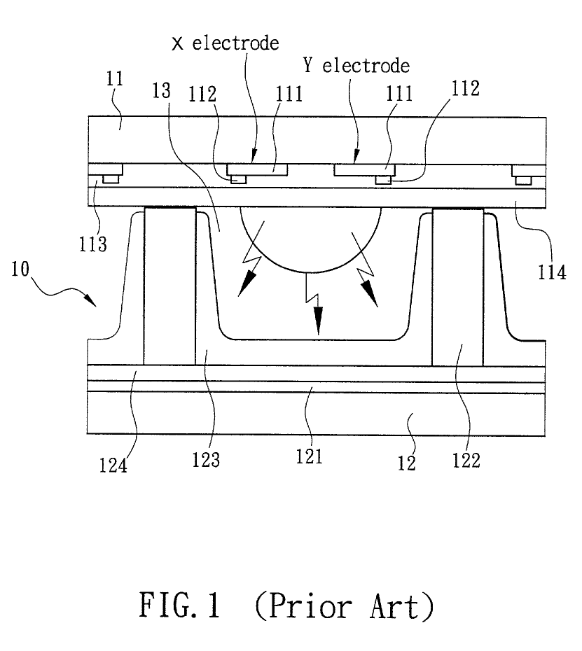

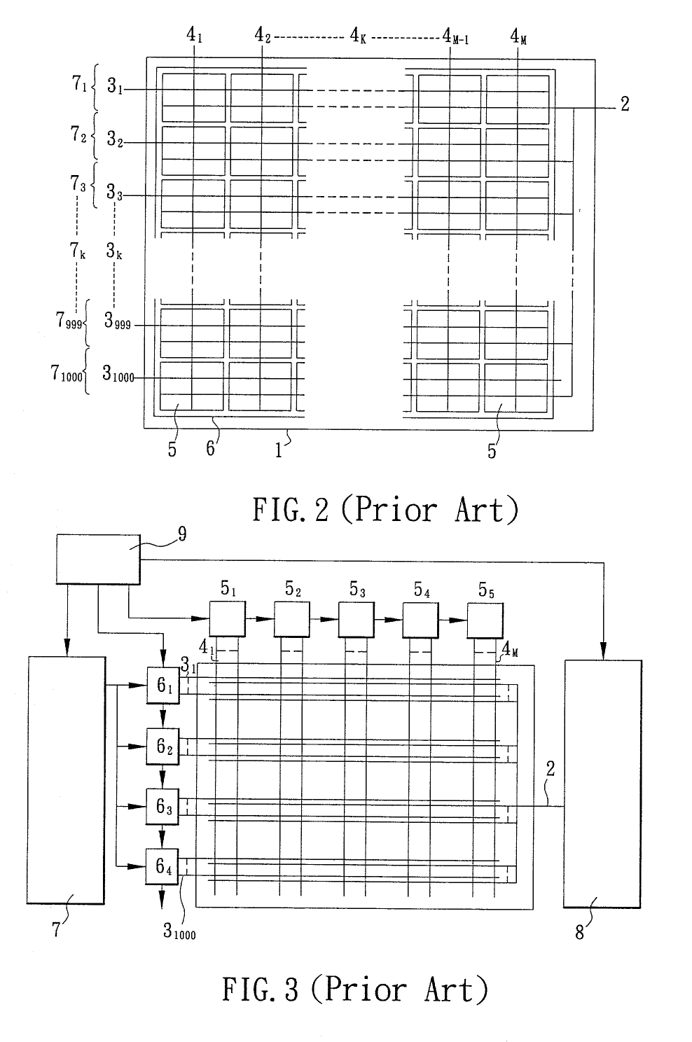

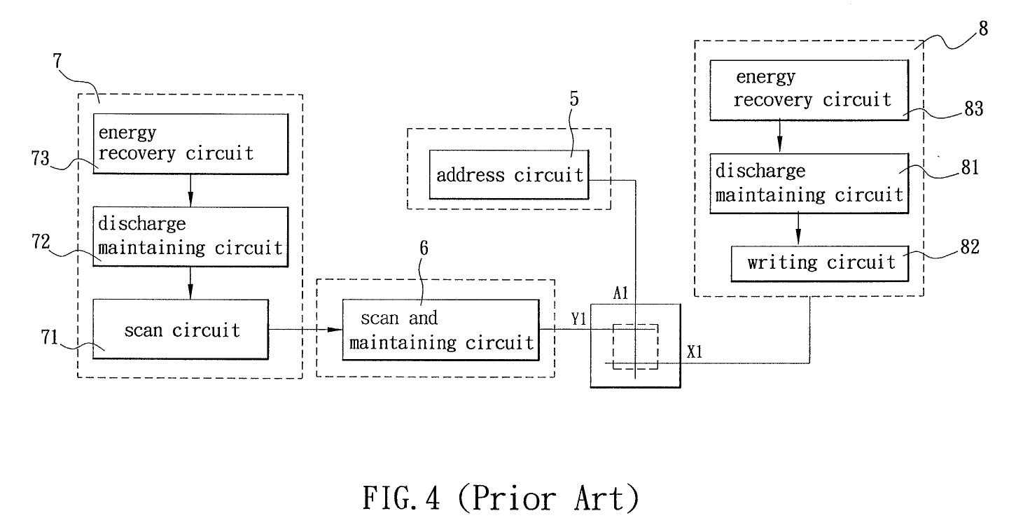

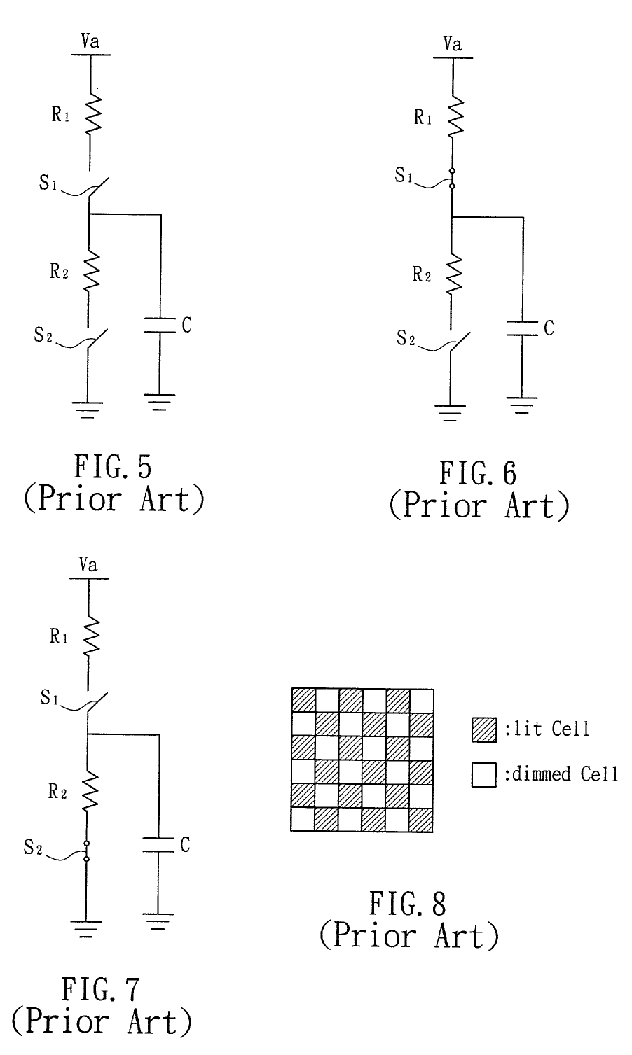

### DETAILED DESCRIPTION OF THE PREFERRED EMBODIMENTS

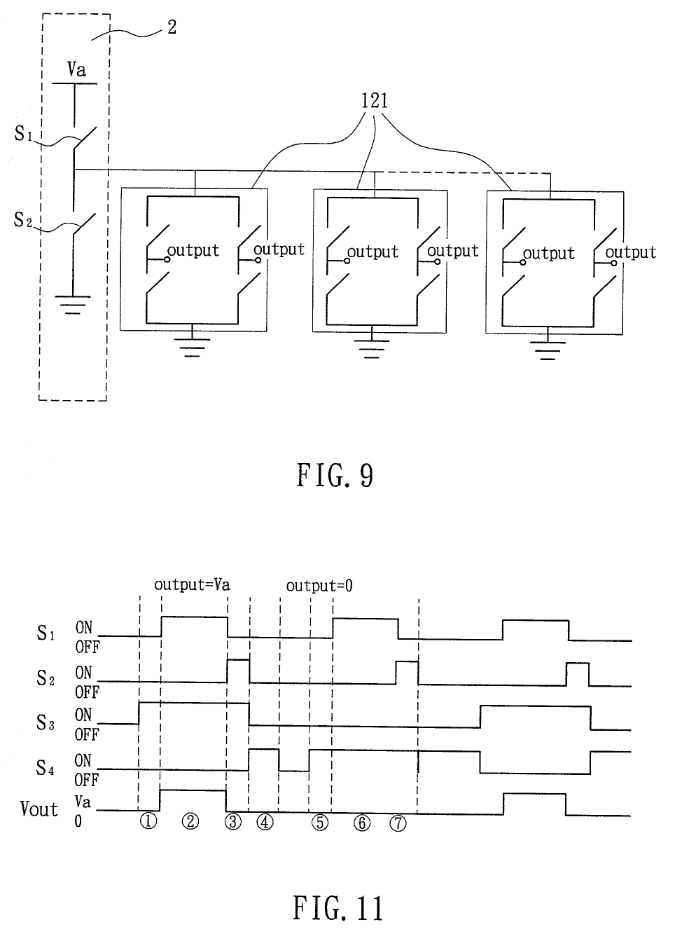

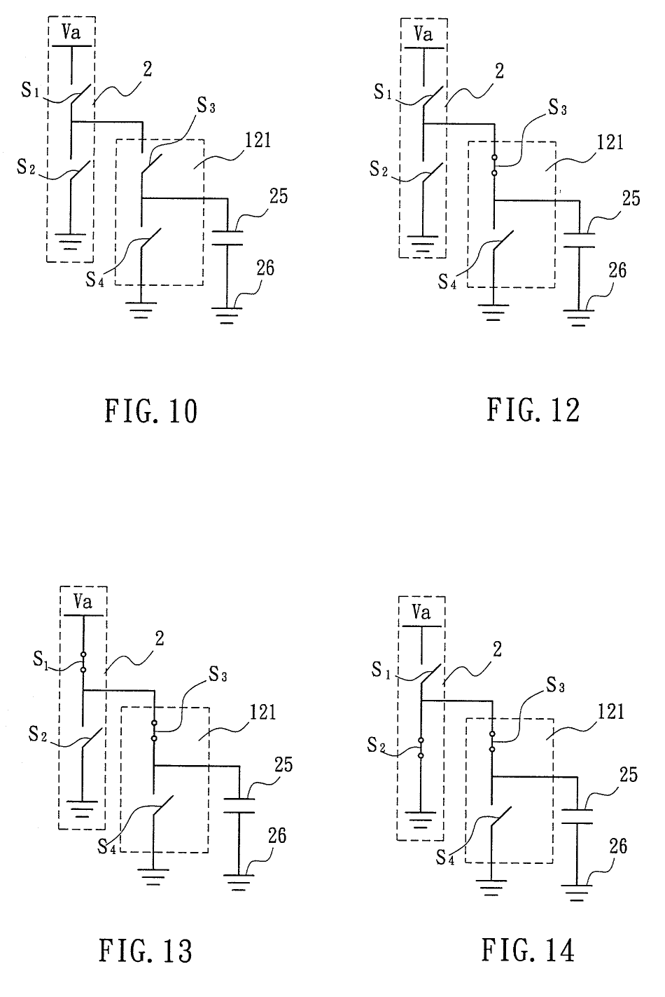

FIG. 9 is a circuit diagram showing an external voltage pulse circuit 2 in parallel connection to a plurality of (three are shown) address electrode drive chips 121 of plasma display panel (PDP) according to the invention. With this configuration, it is possible to solve above overheating problem of address electrode drive chip when the discharge times is extremely high, prevent such drive chip from burning out, and maintain a good image quality. As shown, a control circuit (not shown) is utilized by the address electrode drive chips 121 to control a switching sequence of switches in both the external voltage pulse circuit 2 and address electrode drive chip 121. Accordingly, an external voltage level (Va) (or zero volt) is generated in address electrode drive chip 121. Such voltage is then applied to address electrodes of PDP. Hence, it is possible to totally transfer switching loss in switches of address electrode drive chip 121 during switching to switches of the external voltage pulse circuit 2. This can prevent heat caused by above switching loss from accumulating on address electrode drive chip 121. For illustrating the principles of the invention, FIG. 10 schematically shows an equivalent circuit diagram of an address electrode drive chip 121 driven by a single external voltage pulse circuit 2. The operations and effect of FIG. 10 is as follows:

FIG. 11 is a timing diagram of waveforms illustrating relationship of switches of the external voltage pulse circuit 2 and address electrode drive chip 121 versus output voltage Va of address electrode drive chip 121 of a preferred embodiment. In one cycle of five continuous output waveforms (e.g., S₁, S₂, S₃, S₄ and Vₒᵤₜ) following four steps are performed:

(1) First referring to FIG. 12, a control circuit (not shown) is utilized to switch a third switch S₃ of address electrode drive chip 121 to a closed state and fourth switch S₄ of address electrode drive chip 121 to an open state for preventing heat from generating because there is no switching loss in third switch S₃.

(2) Then referring to FIG. 13, control circuit acts to switch a first switch S₁ to a closed state. At this time, a current path is formed by the external voltage Va, which is from external voltage Va and sequentially passes through the first switch S₁, third switch S₃, external capacitor 25 and ground terminal 26, and returns back to the external voltage Va. As stated above, as “thousand-bird pattern” shown on PDP at the instinct of switching in address electrode drive chip 121, address electrodes is about equivalent to the capacitive load on the drive chip. Such capacitive load is called external capacitor 25. Voltage of external capacitor 25 is an external voltage applied on address electrode. At this cycle, energy loss due to switching switches is totally transferred to first switch S₁. Hence, it is possible to prevent heat from generating because there is no switching loss in both third switch S₃ and fourth switch S₄ of address electrode drive chip 121.

(3) Then referring to FIG. 14, control circuit acts to switch a first switch S₁ to an open state and second switch S₂ to a closed state. At this time, a current path is formed by the external voltage Va, which is from ground terminal 26 and sequentially passes through external capacitor 25, third switch S₃ and second switch S₂, and returns back to ground terminal 26. That is, charges accumulated in external capacitor 25 due to charging by external voltage Va are discharged to ground terminal 26. Hence, voltage of external capacitor 25 is zero. At this cycle, energy loss due to switching switches is totally transferred to second switch S₂. Hence, it is possible to prevent heat from generating because there is no switching loss in both third switch S₃ and fourth switch S₄ of address electrode drive chip 121.

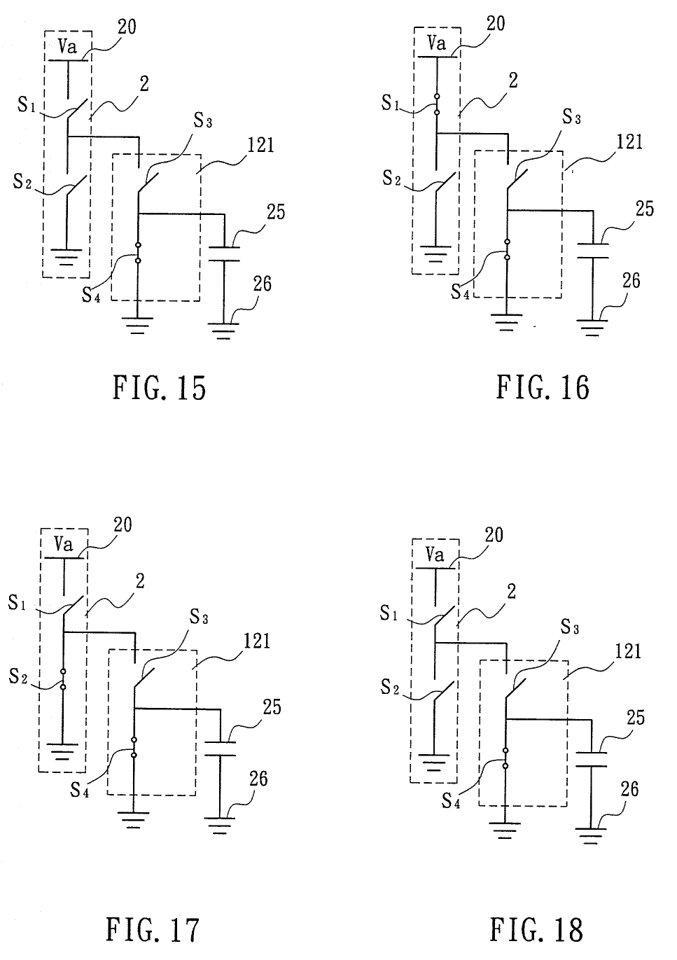

(4) Finally referring to FIG. 15, control circuit acts to switch first switch S₁, second switch S₂, and third switch S₃ to an open state and fourth switch S₄ to a closed state. At this time, a current path is formed by external voltage Va, which is from ground terminal 26 and sequentially passes through external capacitor 25 and fourth switch S₄, and returns back to ground terminal 26. At this time, there is no current on the path since voltage on external capacitor 25 is zero in above step (3). Hence, it is possible to prevent heat from generating because there is no switching loss in both third switch S₃ and fourth switch S₄ of address electrode drive chip 121.

Referring to FIG. 11 again, in the embodiment in a next cycle of five continuous output waveforms (e.g., S₁, S₂, S₃, S₄ and Vₒᵤₜ) following three steps are performed:

(1) First referring to FIG. 16, control circuit acts to switch a first switch S₁ and fourth switch S₄ to a closed state and second switch S₂ and third switch S₃ to an open state. At this time, a current path is formed by external voltage Va, which is from ground terminal 26 and sequentially passes through external capacitor 25 and fourth switch S₄, and returns back to ground terminal 26. At this time, there is no output voltage since voltage on external capacitor 25 is zero. Hence, it is possible to prevent heat from generating because there is no switching loss in fourth switch S₄ of address electrode drive chip 121.

(2) Then referring to FIG. 17, control circuit acts to switch first switch S₁ to an open state and second switch S₂ to a closed state. At this time, a current path same as that shown in FIG. 16 is formed by external voltage Va, which is from ground terminal 26 and sequentially passes through external capacitor 25 and fourth switch S₄, and returns back to ground terminal 26. At this time, there is no output voltage since voltage on external capacitor 25 is zero. Hence, it is possible to prevent heat from generating because there is no switching loss in fourth switch S₄ of address electrode drive chip 121.

(3) Finally referring to FIG. 18, control circuit acts to switch second switch S₂ to an open state. At this time, a current path same as that shown in FIG. 16 is formed by external voltage Va, which is from ground terminal 26 and sequentially passes through external capacitor 25 and fourth switch S₄, and returns back to ground terminal 26. At this time, there is no output voltage since voltage on external capacitor 25 is zero. Hence, it is possible to prevent heat from generating because there is no switching loss in fourth switch S₄ of address electrode drive chip 121.

In view of above, the invention utilizes a control circuit to control a switching sequence of switches in both the external voltage pulse circuit 2 and in address electrode drive chip 121. Accordingly, power loss due to switching switches in address electrode drive chip 121 is totally transferred to switches in the external voltage pulse circuit 2. Hence, it is possible to prevent heat caused by above switching loss in address electrode drive chip 121 from accumulating thereon by designing a simple economic effective circuitry. It is found that energy transferred from address electrode drive chip 121 to first and second switches S₁ and S₂ will accumulate thereon. Hence, first and second switches S₁ and S₂ will be overheated. The invention provides an additional heat dissipation pad on each of switches S₁ and S₂ for increasing heat dissipation capability thereof. This can effectively prevent switches S₁ and S₂from burning due to overheating. While the invention has been described by means of specific embodiments, numerous modifications and variations could be made thereto by those skilled in the art without departing from the scope and spirit of the invention set forth in the claims.

What is claimed is:

1. A method for dissipating heat on a plurality of address electrode drive chips of a plasma display panel (PDP), said method comprising the steps of:
(a) connecting an external voltage pulse circuit to said address electrode drive chips for driving;
(b) enabling a control circuit to control a switching sequence of a plurality of switches in both said external voltage pulse circuit and each of said address electrode drive chips;
(c) generating an external voltage level or zero volt in each of said address electrode drive chips and applying said same to each of a plurality of address electrodes of said PDP; and
(d) totally transferring a switching loss in said switches of each said address electrode drive chips during switching to said switches of said external voltage pulse circuit.

2. The method of claim 1, wherein said external voltage pulse circuit is in parallel connection to each of said address electrode drive chips and comprises a first switch having one end coupled to an external voltage source and a second switch having one end in series connection to the other end of said first switch and the other end coupled to a ground terminal.

3. The method of claim 2, wherein each of said address electrode drive chips is corresponding to one of said address electrodes and comprises a third switch having one end interconnected said first and second switches and a fourth switch having one end in series connection to the other end of said third switch and the other end coupled to said ground terminal.

4. The method of claim 3, wherein each of said address electrodes is formed as an external capacitor having one end interconnecting said third and fourth switches and the other end coupled to said ground terminal at a time of switching each of said address electrode drive chips, and a voltage on each of said address electrodes is an external voltage.

5. The method of claim 4, wherein when an output voltage of each of said address electrode drive chips is said external voltage, in one timing cycle of said external voltage pulse circuit and each of said address electrode drive chips, comprising the steps of:
(e) enabling said control circuit to switch said third switch of each of said address electrode drive chips to a closed state and said fourth switch thereof to an open state for preventing heat from generating because there is no switching loss in said third switch;
(f) enabling said control circuit to switch said first switch to said closed state and forming a first current path by said external voltage, said first current path passing from said external voltage, said first switch, said third switch, said external capacitor, and said ground terminal to return to said external voltage, thereby totally transferring energy loss due to said switches to said first switch;
(g) enabling said control circuit to switch said first switch to said open state and said second switch to said closed state and forming a second current path by said external voltage, and said second current path passing from said ground terminal, said external capacitor, said third switch, and said second switch to return to said ground terminal wherein charges accumulated in said external capacitor due to charging by said external voltage is discharged to said ground terminal for reducing a voltage of said external capacitor to zero and totally transfers energy loss due to said switches to said second switch; and
(h) enabling said control circuit to switch said first, second, and third switches to said open state and said fourth switch to said closed state and forming a third current path by said external voltage, and said third current path passing from said ground terminal, said external capacitor, and said fourth switch to return to said ground terminal wherein there is no current on said third current path since said voltage on said external capacitor is zero in said step (g) and prevents heat from generating because there is no switching loss in both said third and fourth switches.

6. The method of claim 4, wherein when said output voltage of each of said address electrode drive chips is zero, in the other timing cycle of said external voltage pulse circuit and each of said address electrode drive chips, comprising the steps of:
(i) enabling said control circuit to switch said first and fourth switches to said closed state and said second and third switches to said open state and forming said third current path by said external voltage, and said third current path passing from said ground terminal, said external capacitor, and said fourth switch to return to said ground terminal wherein there is no output voltage since said voltage on said external capacitor is zero;
(j) enabling said control circuit to switch said first switch to said open state and said second switch to said closed state and forming said third current path by said external voltage, and said third current path passing from said ground terminal, said external capacitor, said fourth switch, and said second switch to return to said ground terminal wherein there is no output voltage since said voltage on said external capacitor is zero; and
(k) enabling said control circuit to switch said second switch to said open state and forming said third current path by said external voltage, and said third current path passing from said ground terminal, said external capacitor, said fourth switch, and said second switch to return to said ground terminal wherein there is no output voltage since said voltage on said external capacitor is zero.

7. The method of claim 2, further comprising the step of providing a pad on each of said first and second switches for increasing heat dissipation capability thereof.
